(19) United States
(12) Patent Application Publication
(10) Pub. No.: US 2014/0376549 A1
(43) Pub. Date: Dec. 25, 2014

(54) PACKET PROCESSING APPARATUS AND METHOD FOR PROCESSING INPUT PACKET ACCORDING TO PACKET PROCESSING LIST CREATED BASED ON FORWARDING DECISION MADE FOR INPUT PACKET

(71) Applicant: MEDIATEK INC., Hsin-Chu (TW)

(72) Inventor: Kuo-Cheng Lu, Hsinchu City (TW)

(73) Assignee: MEDIATEK INC., Hsin-Chu (TW)

(21) Appl. No.: 14/267,885

(22) Filed: May 1, 2014

Related U.S. Application Data
(60) Provisional application No. 61/837,191, filed on Jun. 20, 2013.

(51) Int. Cl. H04L 12/721; H04L 12/935; H04L 12/18

(52) U.S. Cl. CPC H04L 45/72; H04L 12/18; H04L 49/30
USPC 370/390; 370/419

(57) ABSTRACT

A packet processing method includes receiving a forwarding decision made for an input packet; and creating a packet processing list of the input packet according to the forwarding decision. When the forwarding decision indicates that the input packet is required to undergo first packet processing operations, each including a common processing operation and an individual processing operation, to generate first output packets forwarded via first egress ports, respectively, first information indicative of the first egress ports is recorded in an egress port field of a first session of the packet processing list; second information indicative of the common processing operation shared by all of the first packet processing operations is recorded in a common processing field of the first session; and third information indicative of individual processing operations of the first packet processing operations is recorded in an individual processing field of the first session.

### CROSS REFERENCE TO RELATED APPLICATIONS

This application claims the benefit of U.S. provisional application No. 61/837,191, field on Jun. 20, 2013 and incorporated herein by reference.

### BACKGROUND

The disclosed embodiments of the present invention relate to forwarding packets, and more particularly, to a packet processing method for processing an input packet according to a packet processing list created based on a forwarding decision made for the input packet and a related packet processing apparatus.

A network switch is a computer networking device that links different electronic devices. For example, the network switch receives an input packet generated from a source electronic device connected to it, and transmits output packet(s) derived from the received input packet only to one or more destination electronic devices for which original or modified payload data of the received input packet is meant to be received. In general, the network switch has a packet buffer for buffering packet data of packets received from ingress ports, and forwards the packets stored in the packet buffer through egress ports. If the same packet is requested by a group of destination electronic devices connected to different egress ports of the network switch, a requested packet, also known as a multicast packet, is obtained in a single transmission from a source electronic device connected to one ingress port of the network device, and a multicast operation is performed by the network switch to deliver original or modified copies of the requested packet stored in the packet buffer to the group of destination electronic devices. In the modern packet switches, providing flexible and vendor defined packet forwarding/modification may be a key differentiation. Thus, there is a need for an innovative packet switch design which can support flexible packet modification and/or packet replication.

### SUMMARY

In accordance with exemplary embodiments of the present invention, a packet processing method for processing an input packet according to a packet processing list created based on a forwarding decision made for the input packet and a related packet processing apparatus are proposed to solve the above-mentioned problem.

According to a first aspect of the present invention, an exemplary packet processing method is disclosed. The exemplary packet processing method includes: receiving a forwarding decision made for an input packet; and creating a packet processing list of the input packet according to the forwarding decision. The step of creating the packet processing list includes: when the forwarding decision indicates that the input packet is required to undergo a plurality of first packet processing operations, each including a common processing operation and an individual processing operation, to generate a plurality of first output packets forwarded via a plurality of first egress ports, respectively, recording first information indicative of the first egress ports in an egress port field of a first session of the packet processing list, recording second information indicative of the common processing operation shared by all of the first packet processing operations in a common processing field of the first session of the packet processing list, and recording third information indicative of individual processing operations of the first packet processing operations in an individual processing field of the first session of the packet processing list.

According to a second aspect of the present invention, another exemplary packet processing method is disclosed. The exemplary packet processing method includes: receiving an input packet; receiving a packet processing list created for the input packet; and generating a plurality of first output packets by processing the input packet according to the packet processing list. The step of generating the first output packets includes: reading first information indicative of a plurality of first egress ports from an egress port field of a first session of the packet processing list; reading second information indicative of a common processing operation from a common processing field of the first session of the packet processing list; reading third information indicative of a plurality of individual processing operations respectively involved in generating the first output packets from an individual processing field of the first session of the packet processing list; and performing a plurality of first packet processing operations, each including the common processing operation and one corresponding individual processing operation, upon the input packet to generate the first output packets to the first egress ports, respectively.

According to a third aspect of the present invention, an exemplary packet processing apparatus is disclosed. The exemplary packet processing apparatus includes a forwarding decision making circuit and a packet processing list constructing circuit. The forwarding decision making circuit is configured to generate a forwarding decision for an input packet. The packet processing list constructing circuit is configured to receive the forwarding decision and create a packet processing list of the input packet according to the forwarding decision. When the forwarding decision indicates that the input packet is required to undergo a plurality of first packet processing operations, each including a common processing operation and an individual processing operation, to generate a plurality of first output packets forwarded via a plurality of first egress ports, respectively, the packet processing list constructing circuit records first information indicative of the first egress ports in an egress port field of a first session of the packet processing list, records second information indicative of the common processing operation shared by all of the first packet processing operations in a common processing field of the first session of the packet processing list, and records third information indicative of individual processing operations of the first packet processing operations in an individual processing field of the first session of the packet processing list.

According to a fourth aspect of the present invention, another exemplary packet processing apparatus is disclosed. The exemplary packet processing apparatus includes a packet processing list constructing circuit and a packet processing circuit. The packet processing list constructing circuit is configured to create a packet processing list for an input packet. The packet processing circuit is configured to receive the input packet and the packet processing list, and generate a plurality of first output packets by processing the input packet according to the packet processing list. The packet processing circuit reads first information indicative of a plurality of first egress ports from an egress port field of a first session of the packet processing list, reads second information indicative of a common processing operation from a common processing field of the first session of the packet processing list, reads third information indicative of a plurality of individual processing operations respectively involved in generating the first output packets from an individual processing field of the first session of the packet processing list, and performs a plurality of first packet processing operations, each including the common processing operation and one corresponding individual processing operation, upon the input packet to generate the first output packets to the first egress ports, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a packet processing apparatus using a proposed packet processing framework according to an embodiment of the present invention.

FIG. 2 is a diagram illustrating a data structure of a packet processing list according to an embodiment of the present invention.

FIG. 3 is a diagram illustrating a data structure of a multicast table according to an embodiment of the present invention.

FIG. 4 is a diagram illustrating a data structure of a command chain node according to an embodiment of the present invention.

FIG. 5 is a diagram illustrating a data structure of a command bucket array according to an embodiment of the present invention.

FIG. 6 is a diagram illustrating a packet processing list with two group actions according to an embodiment of the present invention.

FIG. 7 is a diagram illustrating an exemplary modification sequence for generating output packets to one egress port based on the packet processing list shown in FIG. 6.

FIG. 8 is a diagram illustrating an exemplary modification sequence for generating an output packet to another egress port based on the packet processing list shown in FIG. 6.

FIG. 9 is a diagram illustrating an exemplary modification sequence for generating output packets to yet another egress port based on the packet processing list shown in FIG. 6.

FIG. 10 is a flowchart illustrating a per-port group command execution method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The key idea of the present invention is to use a packet processing framework proposed to provide flexible packet modification and/or packet replication. For example, the present invention proposes creating and using a novel packet processing list to achieve flexible packet modification and/or packet replication. It is quite useful in the emergent SDN (Software Defined Network) application to enable flexible processing based on the instructions provided by a remote controller. Further details of the proposed packet processing framework are described as below.

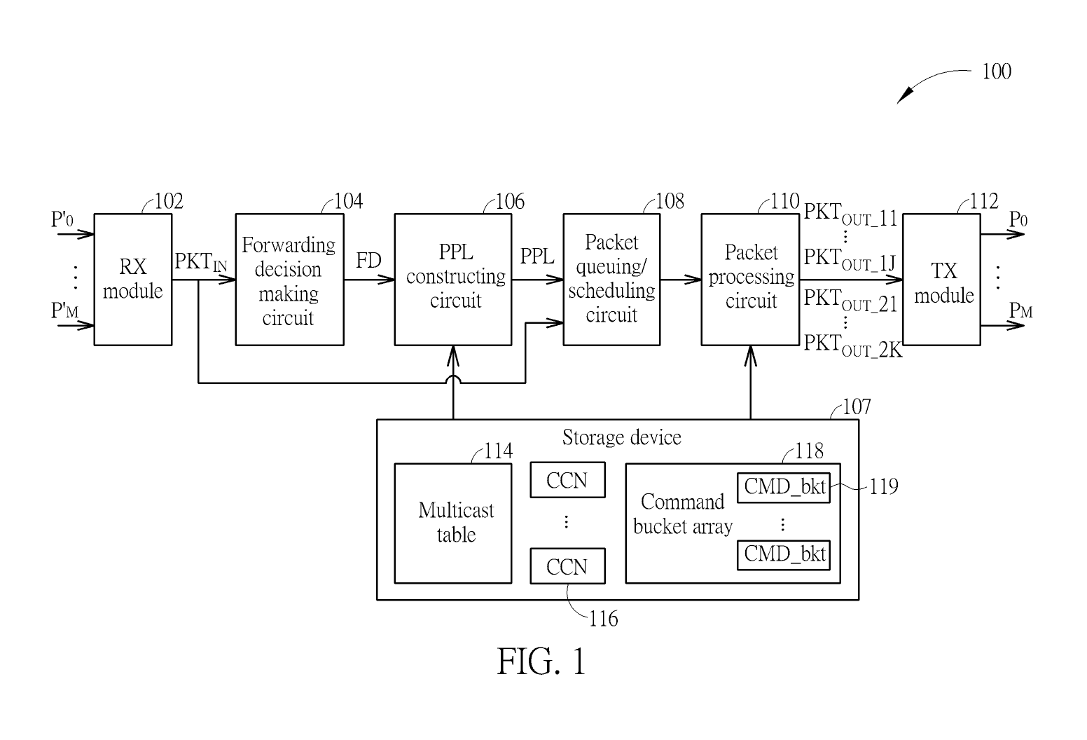

FIG. 1 is a diagram illustrating a packet processing apparatus using a proposed packet processing framework according to an embodiment of the present invention. By way of example, but not limitation, the packet processing apparatus 100 may be a network switch or any electronic device supporting a packet modification function and/or a packet replication function. In this embodiment, the packet processing apparatus 100 includes, but not limited to, a receiver (RX) module 102, a forwarding decision making circuit 104, a packet processing list (PPL) constructing circuit 106, a storage device 107, a packet queuing/scheduling circuit 108, a packet processing circuit 110, and a transmitter (TX) module 112. When the RX module 102 receives an input packet PKT_{IN} from one of ingress ports P₀′-P_{M}′ of the packet processing apparatus 100, the header information of the input packet PKT_{IN} is analyzed by the forwarding decision making circuit 104. For example, the forwarding decision making circuit 104 may employ a table lookup manner to decide how to modify and/or replicate the input packet PKT_{IN} for generating output packets to designated egress ports, and accordingly generate a forwarding decision FD made for the input packet PKT_{IN}, where the forwarding decision FD may include information associated with packet modification and/or packet replication that should be applied to the input packet PKT_{IN}. As any conventional means may be employed to obtain the forwarding decision FD, further description is omitted here for brevity.

The packet processing list constructing circuit 106 receives the forwarding decision FD from the forwarding decision making circuit 104, and creates a packet processing list PPL of the input packet PKT_{IN} according to the forwarding decision FD. More specifically, the packet processing list PPL is created based on the packet modification information and/or the packet replication information given by the forwarding decision FD.

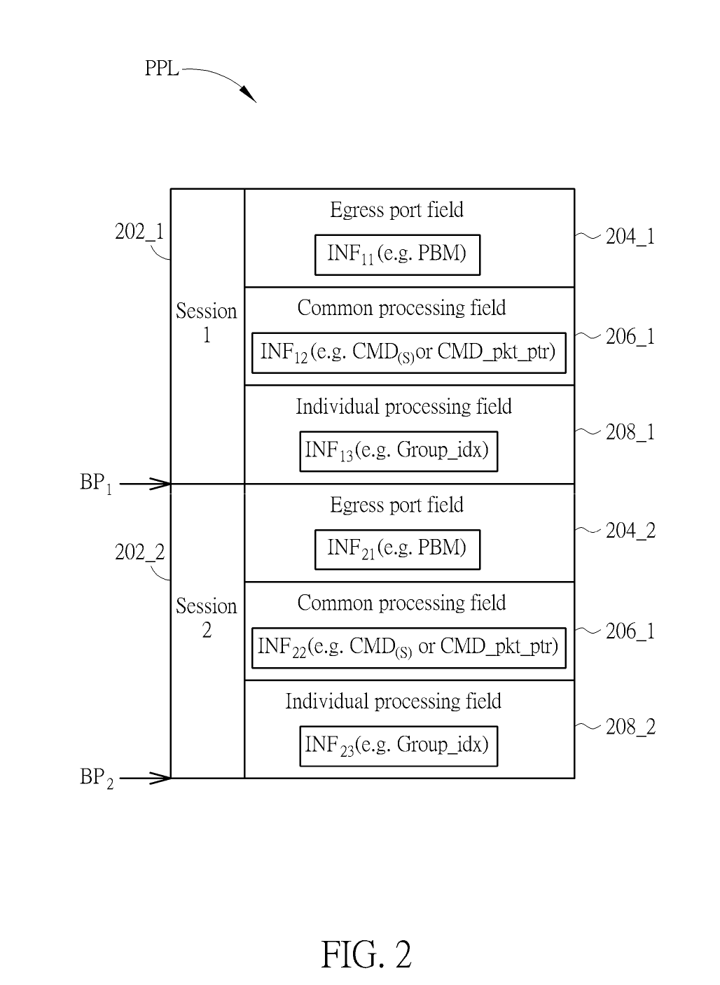

Please refer to FIG. 2, which is a diagram illustrating a data structure of a packet processing list according to an embodiment of the present invention. One packet processing list PPL may include one or more sessions based on the forwarding decision FD made for each input packet PKT_{IN}. In this example, the packet processing list PPL has a plurality of sessions, including a first session 202_1 and a second session 202_2. The first session 202_1 includes an egress port field 204_1, a common processing field 206_1, and an individual processing field 208_1. The second session 202_2 also includes an egress port field 204_2, a common processing field 206_2, and an individual processing field 208_2. It should be noted that the number of sessions included in a packet processing list created for one input packet to be forwarded and the number of data fields included in each session of the packet processing list are for illustrative purposes only. For example, the packet processing list PPL shown in FIG. 2 may further include another session appended to the second session 202_2. For another example, each of the first session 202_1 and the second session 202_2 may include additional data field(s), such as a class of service (CoS) field.

When the forwarding decision FD indicates that the input packet PKT_{IN} is required to undergo a plurality of first packet processing operations, each including a common processing operation and an individual processing operation, to generate a plurality of first output packets PKT_{OUT}_{_{—}}11-PKT_{OUT}_{_{—}}1J forwarded via a plurality of first egress ports selected from egress ports P₀-P_{M} of the packet processing apparatus 100, respectively. The packet processing list constructing circuit 106 records first information INF₁₁ indicative of the first egress ports in the egress port field 204_1 of the first session 202_1 of the packet processing list PPK, records second information INF₁₂ indicative of the common processing operation shared by all of the first packet processing operations in the common processing field 206_1 of the first session 202_1 of the packet processing list PPL, and records third information INF₁₃ indicative of individual processing operations of the first packet processing operations in the individual processing field 208_1 of the first session 202_1 of the packet processing list PPL.

In a case where the first session 202_1 is capable of recording all packet processing operations required to process the input packet PKT_{IN}, the packet processing list PPL may have a single session (e.g., first session 202_1) only. In another case where the input packet PKT_{IN} is required to undergo the aforementioned first packet processing operations as well as a plurality of second processing operations, and each of the second processing operations includes the common processing operation (which is shared by the first and second packet processing operations), another common processing operation (which is shared by all of the second packet processing operations, but not included in any of the first packet processing operations), and an individual processing operation, the second session 202_2 may be used. Specifically, when the forwarding decision FD further indicates that the input packet PKT_{IN} is required to undergo the second packet processing operations, each including one common processing operation, another common processing operation and one individual processing operation, to generate a plurality of second output packets PKTOUT_21-PKTOUT_2K forwarded via a plurality of second egress ports selected from the egress ports P₀-P_{M} of the packet processing apparatus 100, respectively, the packet processing list constructing circuit 106 records fourth information INF₂₁ indicative of the second egress ports in the egress port field 204_2 of the second session 202_2 of the packet processing list PPL, records fifth information INF₂₂ indicative of the another common processing operation shared by all of the second packet processing operations but not the first packet processing operations in the common processing field 206_2 of the second session 202_2 of the packet processing list PPL, and records sixth information INF₂₃ indicative of individual processing operations of the second packet processing operations in the individual processing field 208_2 of the second session 202_2 of the packet processing list PPL.

As mentioned above, the common processing operation shared by the first packet processing operations is also shared by the second packet processing operations. However, the common processing operation shared by the second packet processing operations is not shared by the first packet processing operations. In this embodiment, the fifth information INF₂₂ in the common processing field 206_2 does not indicate the common processing operation shared by the first and second packet processing operations, and only indicates the common processing operation shared by the second packet processing operations but not the first packet processing operations. Specifically, in accordance with the proposed packet processing list design, the second session 202_2 would have one common processing operation inherited from the first session 202_1. More specifically, a later session would have common processing operation(s) inherited from former session(s) and one common processing operation not inherited from any former session. Hence, concerning each of the second packet processing operations, the second information INF₁₂ in the common processing field 206_1 of the first session 202_1 and the fifth information INF₂₂ in the common processing field 2062 of the second session 202_2 should be jointly considered.

Further, to notify the following packet processing circuit 110 of the sequence of sessions in the same packet processing list PPL, one break point is used to mark the end of each session. As shown in FIG. 1, the break point BP₁ indicates the end of the first session 202_1, and the break point BP₂ indicates the end of the second session 202_2. Since the break point BP₁ is before the break point BP₂, command(s) obtained from the common processing field before the break point BP₁ and command(s) obtained from the common processing field between the break points BP₁ and BP₂ should be considered in the generation of output packets PKT_{OUT}_{_{—}}21-PKT_{OUT}_{_{—}}2K.

In one exemplary design, each of first information INF₁₁ and fourth information INF₂₁ may be a port bit map (PBM). As shown in FIG. 1, the packet processing apparatus 100 has egress ports P₀-P_{M}. Hence, the PBM has a bit length M equal to the number of egress ports P₀-P_{M}. Each bit position of the PBM can be one bit corresponding to one of the egress ports P₀-P_{M}. Besides, each bit position of the PBM can be set by a conditional flag used to indicate whether a corresponding egress port is selected for outputting an output packet. For example, the conditional flag for a bit position is asserted when a bit at the bit position is set by ‘1’, and the conditional flag for the bit position is de-asserted when the bit at the bit position is set by ‘0’.

Thus, the first egress ports selected for outputting the first output packets PKT_{OUT}_{_{—}}11-PKT_{OUT}_{_{—}}1J can be indicated by an M-bit PBM with J bits set by ‘1’ and remaining bits set by ‘0’. Similarly, the second egress ports selected for outputting the second output packets PKT_{OUT}_{_{—}}21-PKT_{OUT}_{_{—}}2K can be indicated by another M-bit PBM with K bits set by ‘1’ and remaining bits set by ‘0’. It should be noted that, based on the forwarding decision of each input packet, the first egress ports may be totally different from the second egress ports, or the first egress ports may have one or more egress ports also included in the second egress ports. In other words, one output packet generated from applying one first packet processing operation to the input packet PKT_{IN} and another output packet generated from applying one second packet processing operation to the same input packet PKT_{IN} may be forwarded through the same egress port or different egress ports, depending upon the actual forwarding decision FD made for the input packet PKT_{IN}.

In one exemplary design, the second information INF₁₂ may record each packet processing command CMD of the common processing operation shared by the first processing operations (or shared by the first and second packet processing operations), or may record a command bucket pointer CMD_pkt_ptr which points to a command bucket CMD_bkt 119 in a command bucket array 118 stored in the storage device 107, where the command bucket CMD_bkt stores each packet processing command of the common processing operation shared by the first packet processing operations (or shared by the first and second packet processing operations).

Similarly, the fifth information INF₂₂ may record each packet processing command CMD of another common processing operation shared by the second processing operations but not the first processing operations, or may record a command bucket pointer CMD_pkt_ptr which points to a command bucket CMD_bkt 119 in the command bucket array 118, where the command bucket CMD_bkt stores each packet processing command of the another common processing operation shared by the second packet processing operations but not the first processing operations.

As mentioned above, the third information INF₁₃ is indicative of individual processing operations of the first packet processing operations, and the sixth information INF₂₃ is indicative of individual processing operations of the second packet processing operations. In one exemplary design, the third information INF₁₃ may record an index value Group_idx of an entry in a multicast table 114 stored in the storage device 107, such that individual processing operations of the first packet processing operations can be indirectly determined by means of the multicast table 114. Similarly, the sixth information INF₂₃ may record another index value Group_idx of an entry in the multicast table 114 stored in the storage device 107, such that individual processing operations of the second packet processing operations can be indirectly determined by means of the multicast table 114.

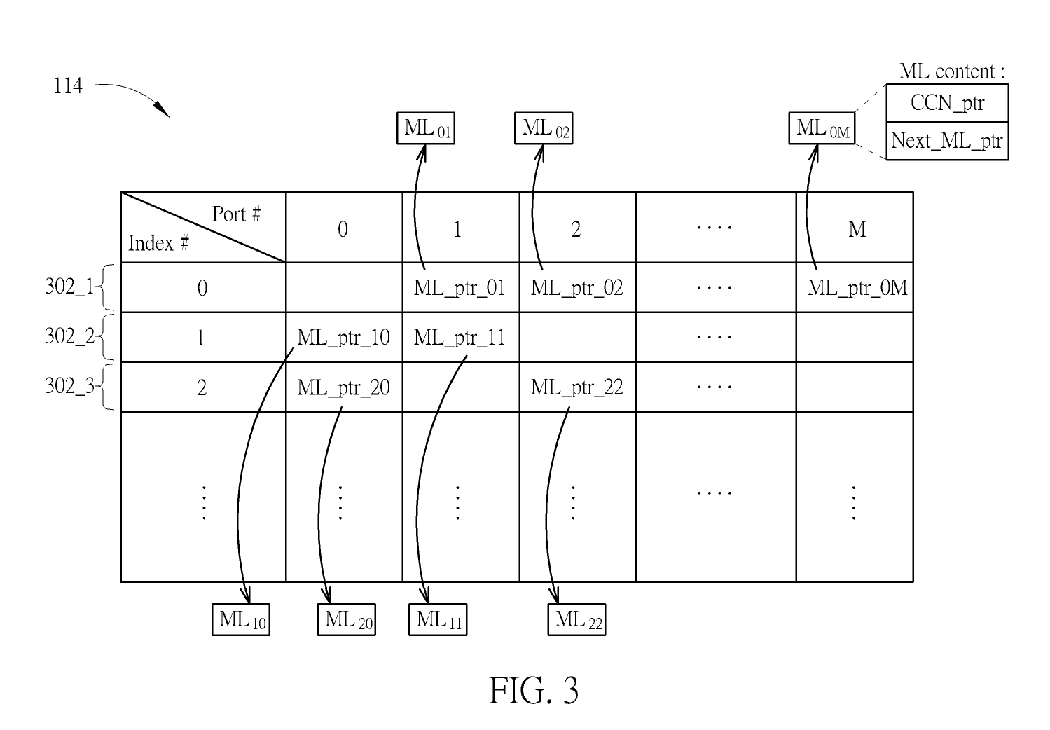

Please refer to FIG. 3, which is a diagram illustrating a data structure of a multicast table according to an embodiment of the present invention. In this embodiment, the multicast table 114 is configured to have a plurality of entries (e.g., 302_1, 302_2, 303_3) indexed by a plurality of different index values (e.g., Group_idx=0, Group_idx=1, Group_idx=2), and each of the entries is associated with at least one multicast list (ML) corresponding to at least one egress port. For example, the first entry 302_1 of the multicast table 114 at least includes multicast list pointers ML_ptr_01, ML_ptr_02 and ML_ptr_0M which point to multicast lists ML₀₁, ML₀₂, ML_{0M} corresponding to egress ports P₁, P₂ and P_{M}, respectively; the second entry 302_2 of the multicast table 114 at least includes multicast list pointers ML_ptr_10 and ML_ptr_11 which point to multicast lists ML₁₀, ML₁₁ corresponding to the egress ports P₀ and P₁, respectively; and the third entry 302_3 of the multicast table 114 at least includes multicast list pointers ML_ptr_20 and ML_ptr_22 which point to multicast lists ML₂₀, ML₂₂ corresponding to egress ports P₁, P₂, respectively.

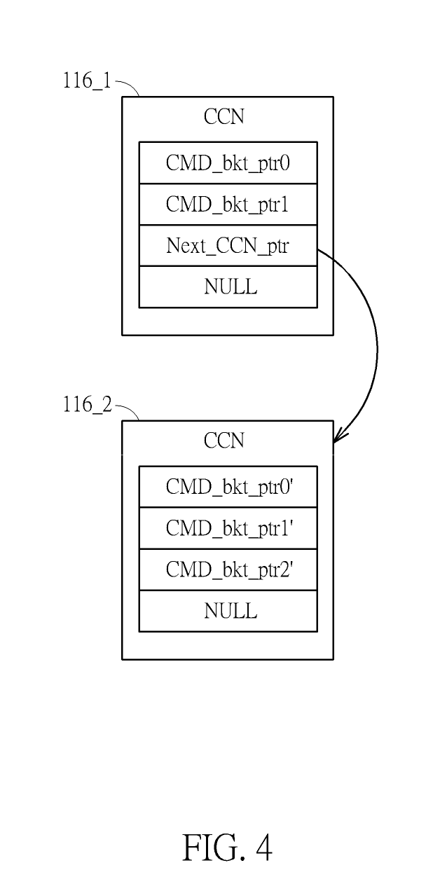

Each of the multicast lists in the multicast table 114 has one command chain node (CCN) pointer CCN_ptr which points to a CCN 116 stored in the storage device 107. Please refer to FIG. 4, which is a diagram illustrating a data structure of a command chain node according to an embodiment of the present invention. Each CCN has at least one command bucket pointer each pointing to a command bucket corresponding to an individual processing operation involved in generating an output packet. For example, each CCN is allowed to have at most four command bucket pointers. As shown in FIG. 4, the CCN 116_1 has two command bucket pointers CMD_bkt_ptr0, CMD_bkt_ptr1 which point to two command buckets 119 in the command bucket array 118, and the CCN 1162 has three command bucket pointers CMD_bkt_ptr0′, CMD_bkt_ptr1′, CMD_bkt_ptr12 which point to three command buckets 119 in the command bucket array 118.

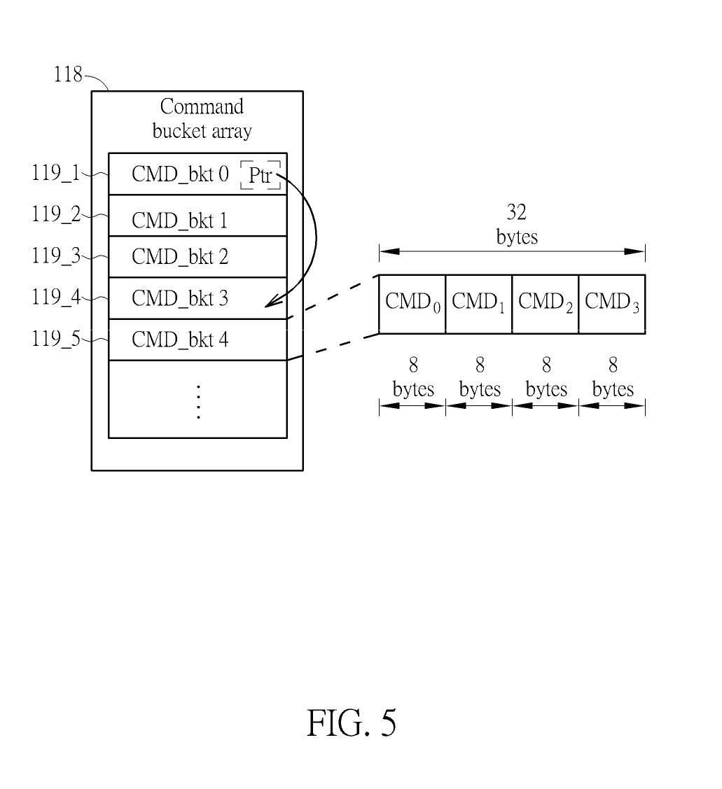

Please refer to FIG. 5, which is a diagram illustrating a data structure of a command bucket array according to an embodiment of the present invention. The command bucket array 118 is configured to have a plurality of command buckets (e.g., 119_1, 119_2, 119_3, 119_4, 119_5). In this embodiment, each command bucket in the command bucket array 118 has 32 bytes, and each command in a command bucket has 8 bytes. Hence, each command bucket is allowed to have at most four commands CMD₀, CMD₁, CMD₂, CMD₃. In this embodiment, the command CMD₀/CMD₁/CMD₂/CMD₃ may be an “insert” command used for adding certain new information to a packet, a “delete” command used for removing certain existing information from a packet, or a “modify” command used for changing certain existing information of a packet.

To further enhance the flexibility of packet modification and/or packet replication using the proposed packet processing list, the proposed packet processing framework may support multicast list chaining, CCN chaining, and/or command bucket chaining. Concerning the multicast list chaining, please refer to FIG. 3 again. Besides one CCN pointer CCN_ptr, the multicast list may further have a next multicast list pointer Next_ML_ptr. In a case where a next multicast list pointer Next_ML_ptr of a first multicast list corresponding to a specific egress port is set by a NULL value, an output packet is generated to the specific egress port by processing the input packet PKT_{IN} based on a CCN pointed to by a CCN pointer CCN_ptr of the first multicast list. In another case where the next multicast list pointer Next_ML_ptr of the first multicast list corresponding to the specific egress port is set by a valid pointer value to point to a second multicast list, one output packet is generated to the specific egress port by processing the input packet PKT_{IN} based on a CCN pointed to by a CCN pointer CCN_ptr of the first multicast list, and another output packet is generated to the same specific egress port by processing the input packet PKT_{IN} based on a CCN pointed to by a CCN pointer CCN_ptr of the second multicast list linked to the first multicast list. To put it simply, each multicast list represents one individual packet modification/replication applied to the input packet PKT_{IN}.

Concerning the CCN chaining, please refer to FIG. 4 again. As shown in FIG. 4, the CCN 116_1 has a next CCN pointer Next_CCN_ptr which points to the CCN 116_2. Hence, when the CCN 116_1 is selected due to a CCN pointer CCN_ptr in a selected multicast list, all of the command bucket pointers CMD_bkt_ptr0, CMD_bkt_ptr1, CMD_bkt_ptr0′, CMD_bkt_ptr1′, CMD_bkt_ptr2′ included in the CCNs 116_1 and 116_2 will be selected and used.

Concerning the command bucket chaining, please refer to FIG. 5 again. As shown in FIG. 5, there is a next command bucket pointer Ptr at the end of the command bucket 119_1. For example, the command bucket 119_1 may have three commands CMD₀-CMD₂ and one next command bucket pointer Ptr. In this embodiment, the next command bucket pointer Ptr points to the command bucket 119_3 between command buckets 119_2 and 119_4. Hence, when the command bucket 119_1 is selected due to a command bucket pointer in one selected CCN, all of the commands stored in the command buckets 119_1 and 119_3 will be selected and used.

Please refer to FIG. 1 again. The input packet PKT_{IN} and the associated packet processing list PPL are both enqueued into one of a plurality of output queues of the packet queuing/scheduling circuit 108. The packet queuing/scheduling circuit 108 makes scheduler decisions to schedule dequeue operations performed upon the output queues for dequeuing packets and associated packet processing lists PPL from the output packets. When the input packet PKT_{IN} and the associated packet processing list PPL are dequeued, the following packet processing circuit 110 is operative to perform packet modification and/or packet replication upon the input packet PKT_{IN} based on its packet processing list PPL, and then send a plurality of modified input packets (i.e., output packets) to egress ports through the TX module 112. For example, output packets PKT_{OUT}_{_{—}}11-PKT_{OUT}_{_{—}}1J are generated by processing the input packet PKT_{IN} based on full packet processing information given by the first session 202_1 of the packet processing list PPL, and output packets PKT_{OUT}_{_{—}}21-PKT_{OUT}_{_{—}}2K are generated by processing the same input packet PKT_{IN} based on partial packet processing information given by the first session 202_1 of the packet processing list PPL (e.g., second information INF₁₂ in the common processing field 206_1 of first session 202_1) and full packet processing information given by the second session 202_2 of the packet processing list PPL.

For better understanding of technical features of the present invention, an example of generating output packets based on an input packet and a packet processing list created for the input packet is detailed as below.

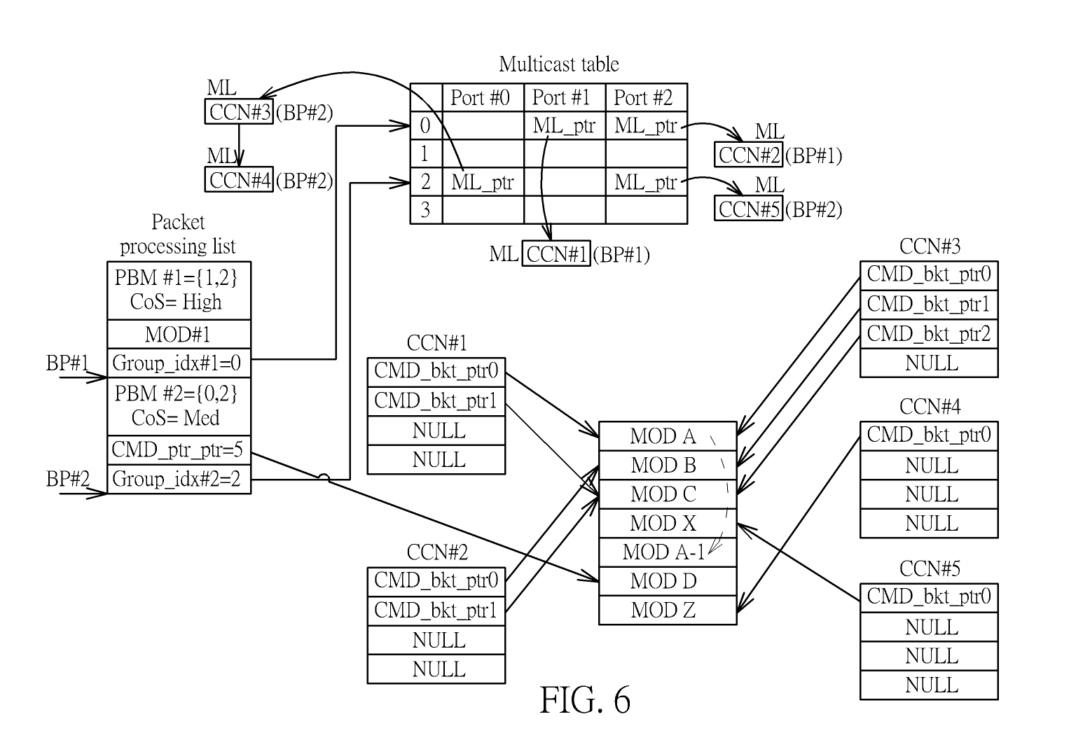

Please refer to FIG. 6, which is a diagram illustrating a packet processing list with two group actions according to an embodiment of the present invention. In this example, there are two group actions in the packet processing list. The first session of the packet processing list describes the egress ports (port #1 and port #2) and CoS (High), and further describes a “modify” command (MOD#1) intended for common packet processing and a group action (Group_idx #1=0) intended for individual packet processing. The second session of the packet processing list describes the egress ports (port #0 and port #2) and CoS (Medium), and further describes a command bucket pointer (CMD_bkt_ptr=5) intended for common packet processing and a group action (Group_idx #1=2) intended for individual packet processing. In the packet processing circuit 110, the first session of the packet processing list is executed first. Group_idx #1 and PBM #1 are used to index the multicast table to get two multicast lists which contain CCN pointers pointing to CCN#1 (port #1) and CCN#2 (port #2). In CCN #1, there are two command bucket pointers for retrieving two command buckets MOD A and MOD C, respectively. In CCN#2, there are two command bucket pointers pointing to command buckets MOD B and MOD C, respectively.

Next, the second session of the packet processing list is executed. Group_idx #2 and PBM #2 are used to index the multicast table to get two multicast lists which contain CCN pointers pointing to CCN #3 and CCN#5, where CCN #4 is linked to CCN #3 due to CCN chaining. In CCN #3, there are three command bucket pointers for retrieving three command buckets MOD A, MOD B and MOD C, respectively, where command bucket MOD A-1 is linked to command bucket MOD A due to command bucket chaining. In CCN#4, there is one command bucket pointer for retrieving one command bucket MOD Z. In CCN#5, there is one command bucket pointer for retrieving one command bucket MOD X.

With regard to generation of a first group of output packets, the common processing operation described in the first session (i.e., the “modify” command MOD#1) and the individual processing operations described in the first session (i.e., command buckets retrieved based on Group_idx #1) are executed by the packet processing circuit 110, sequentially.

With regard to generation of a second group of output packets, the common processing operation described in the first session (i.e., the “modify” command MOD#1), the common processing operation described in the second session (i.e., the “modify” command MOD#2), and the individual processing operations described in the second session (i.e., command buckets retrieved based on Group_idx #2) are executed by the packet processing circuit 110, sequentially.

As mentioned above, the third information INF₁₃/INF₂₃ may record an index value Group_idx of an entry in the multicast table 114. Hence, the individual processing operations are decided based on CCN(s) selected through performing a table lookup operation upon the multicast table 114. However, this is not meant to be a limitation of the present invention. Alternatively, the aforementioned index value Group_idx may be directly set by at least one CCN pointer (not shown), such that no multicast table lookup is needed in this case. To put it simply, the third information INF₁₃/INF₂₃ may be used to record a CCN pointer, depending upon the actual design consideration. This also falls within the scope of the present invention.

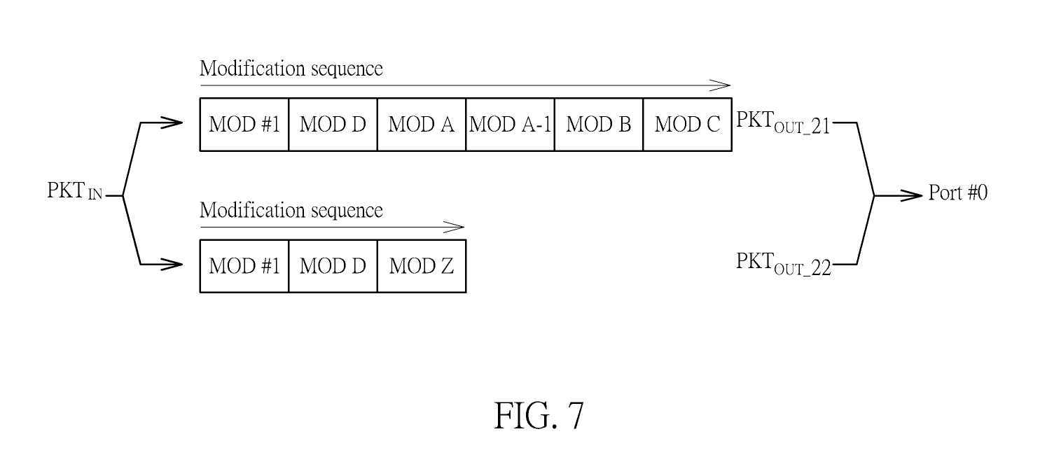

The packet modification sequence for generating output packets (e.g., PKT_{OUT}_{_{—}}21 and PKT_{OUT}_{_{—}}22) to one egress port (e.g., Port #0) based on the packet processing list in FIG. 6 is shown in FIG. 7. The “modify” command MOD#1 in a common processing field of the first session, the command bucket MOD D retrieved via the command packet pointer CMD_pkt_ptr=5 in a common processing field of the second session, and command buckets of CCN#3 retrieved from a multicast list indexed by Group_idx #2 in an individual processing field of the second session and port #0 in an egress port field of the second session are sequentially executed for modifying an input packet to generate the output packet PKT_{OUT}_{_{—}}21. Besides, the “modify” command MOD#1 in a common processing field of the first session, the command bucket MOD D retrieved via the command packet pointer CMD_pkt_ptr=5 in a common processing field of the second session, and a command bucket of CCN#4 retrieved due to multicast list chaining are sequentially executed for modifying the same input packet to generate the output packet PKT_{OUT}_{_{—}}22.

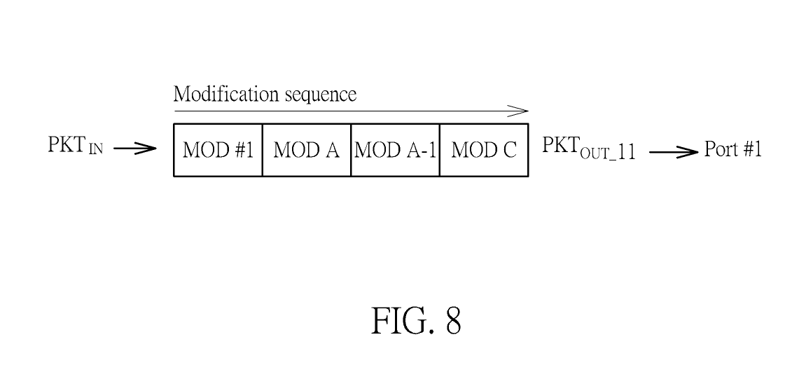

The packet modification sequence for generating an output packet (e.g., PKT_{OUT}_{_{—}}11) to another egress port (e.g., Port #1) based on the packet processing list in FIG. 6 is shown in FIG. 8. The “modify” command MOD#1 in the common processing field of the first session, and command buckets of CCN#1 retrieved from a multicast list indexed by Group_idx #1 in an individual processing field of the first session and port #1 in an egress port field of the first session are sequentially executed for modifying the same input packet to generate the output packet PKT_{OUT}_{_{—}}11.

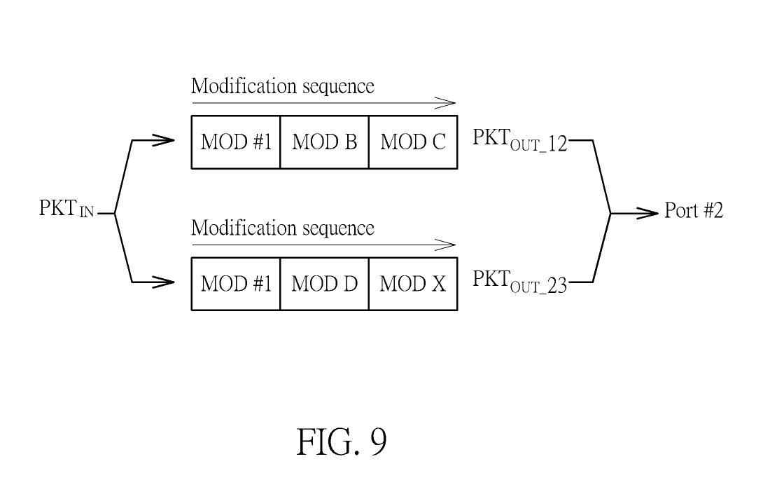

The packet modification sequence for generating output packets (e.g., PKT_{OUT}_{_{—}}12 and PKT_{OUT}_{_{—}}23) to yet another egress port (e.g., Port #2) based on the packet processing list in FIG. 6 is shown in FIG. 9. The “modify” command MOD#1 in the common processing field of the first session and command buckets of CCN#2 retrieved from a multicast list indexed by Group_idx #1 in the individual processing field of the first session and port #2 in the egress port field of the first session are sequentially executed for modifying the same input packet to generate the output packet PKT_{OUT}_{_{—}}12. Besides, the “modify” command MOD#1 in the common processing field of the first session, the command bucket MOD D retrieved via the command packet pointer CMD_pkt_ptr=5 in the common processing field of the second session, and a command bucket of CCN#5 retrieved from a multicast list indexed by Group_idx #2 in the individual processing field of the second session and port #2 in the egress port field of the second session are sequentially executed for modifying the same input packet to generate the output packet PKT_{OUT}_{_{—}}23.

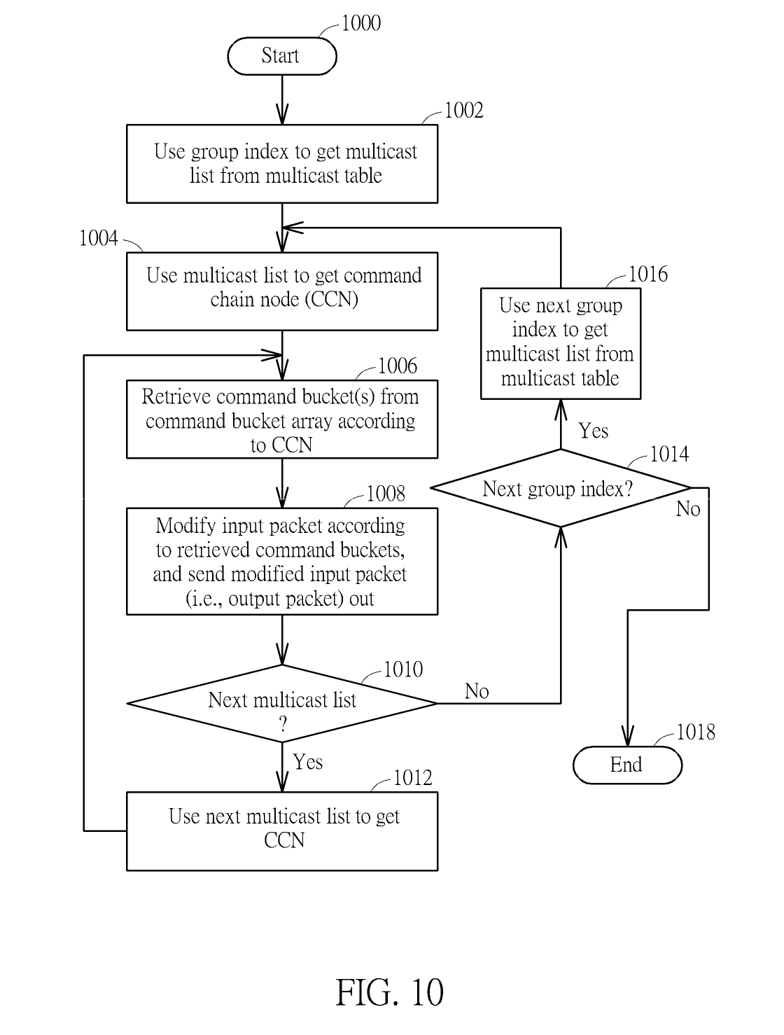

FIG. 10 is a flowchart illustrating a per-port group command execution method according to an embodiment of the present invention. Provided that the result is substantially the same, the steps are not required to be executed in the exact order shown in FIG. 10. In a preferred embodiment of the present invention, the packet processing circuit 110 may include a plurality of packet processing engines, each configured to generate output packets to one egress port. Hence, when generating one or more output packets to a corresponding egress port, each packet processing engine may employ the per-port group command execution method to apply individual processing operations to the input packet PKT_{IN}. For example, each session in the packet is ended with a group index (i.e., an index value recorded in an individual processing field), and the group indices are processed sequentially per physical egress port. However, this is for illustrative purposes only, and is not meant to be a limitation of the present invention. Any electronic device employing the proposed packet processing framework falls within the scope of the present invention.

The per-port group command execution method may be briefly summarized as below.

Step 1000: Start.

Step 1002: Use a group index to get a multicast list from the multicast table.

Step 1004: Use the multicast list to get a command chain node (CCN).

Step 1006: Retrieve command bucket(s) from a command bucket array according to the CCN. The retrieved command bucket(s) may be retrieved based on the CCN only if there is no CCN chaining used by the CCN, and the retrieved command bucket(s) may be retrieved based on the CCN and additional CCN(s) linked to the CCN if there is CCN chaining used by the CCN.

Step 1008: Modify an input packet according to the retrieved command buckets, and send a modified input packet (i.e., an output packet) out.

Step 1010: Check if there is a next multicast list linked by multicast list chaining. If yes, go to step 1012; otherwise, go to step 1014.

Step 1012: Use the next multicast list to get a CCN. Go to step 1006.

Step 1014: Check if there is a next group index which is not processed yet. If yes, go to step 1016; otherwise, go to step 1018.

Step 1016: Use the next group index to get a multicast list from the multicast table. Go to step 1004.

Step 1018: End.

As illustrated by the per-port group command execution sequence in FIG. 10, group indices in a packet processing list created for an input packet are processed sequentially, multicast lists associated with the same group index are processed sequentially, and CCNs associated with the same multicast list are processed sequentially. Besides, a modified input packet is generated each time one multicast list is processed. As a person skilled in the art can readily understand details of each step shown in FIG. 10 after reading above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet processing method, comprising:
receiving a forwarding decision made for an input packet; and
creating a packet processing list of the input packet according to the forwarding decision, wherein the step of creating the packet processing list comprises:
when the forwarding decision indicates that the input packet is required to undergo a plurality of first packet processing operations, each including a common processing operation and an individual processing operation, to generate a plurality of first output packets forwarded via a plurality of first egress ports, respectively:
recording first information indicative of the first egress ports in an egress port field of a first session of the packet processing list;
recording second information indicative of the common processing operation shared by all of the first packet processing operations in a common processing field of the first session of the packet processing list; and
recording third information indicative of individual processing operations of the first packet processing operations in an individual processing field of the first session of the packet processing list.

2. The packet processing method of claim 1, wherein the first information is a port bit map (PBM).

3. The packet processing method of claim 1, wherein the second information records each packet processing command of the common processing operation.

4. The packet processing method of claim 1, wherein the second information records a command bucket pointer which points to a command bucket, and the command bucket stores each packet processing command of the common processing operation.

5. The packet processing method of claim 1, wherein the third information records an index value of an entry in a multicast table; the entry is associated with a plurality of multicast lists corresponding to the first egress ports, respectively; each of the multicast lists records a command chain node (CCN) pointer; and the CCN pointer points to a CCN having at least one command bucket pointer each pointing to a command bucket corresponding to an individual processing operation involved in generating an output packet.

6. The packet processing method of claim 5, wherein a command bucket pointed to by one of the at least one command bucket of the CCN includes a next command bucket pointer which points to a next command bucket.

7. The packet processing method of claim 5, wherein at least one of the multicast lists further includes a next multicast list pointer which points to a next multicast list; and the next multicast list records a CCN pointer which points to a CCN having at least one command bucket pointer each pointing to a command bucket corresponding to another individual processing operation involved in generating another output packet.

8. The packet processing method of claim 5, wherein the CCN further has a next CCN pointer which points to a next CCN, and the next CCN has at least one command bucket pointer each pointing to a command bucket corresponding to the individual processing operation involved in generating the output packet.

9. The packet processing method of claim 1, wherein the third information records at least one command chain node (CCN) pointer, and the CCN pointer points to a CCN having at least one command bucket pointer each pointing to a command bucket corresponding to an individual processing operation involved in generating an output packet.

10. The packet processing method of claim 1, wherein the step of creating the packet processing list further comprises:
when the forwarding decision further indicates that the input packet is required to undergo a plurality of second packet processing operations, each including the common processing operation, another common processing operation and an individual processing operation, to generate a plurality of second output packets forwarded via a plurality of second egress ports, respectively:
recording fourth information only indicative of the second egress ports in an egress port field of a second session of the packet processing list;
recording fifth information indicative of the another common processing operation shared by all of the second packet processing operations in a common processing field of the second session of the packet processing list; and
recording sixth information indicative of individual processing operations of the second packet processing operations in an individual processing field of the second session of the packet processing list.

11. A packet processing method, comprising:
receiving an input packet;
receiving a packet processing list created for the input packet; and
generating a plurality of first output packets by processing the input packet according to the packet processing list, wherein the step of generating the first output packets comprises:
reading first information indicative of a plurality of first egress ports from an egress port field of a first session of the packet processing list;
reading second information indicative of a common processing operation from a common processing field of the first session of the packet processing list;
reading third information indicative of a plurality of individual processing operations respectively involved in generating the first output packets from an individual processing field of the first session of the packet processing list; and
performing a plurality of first packet processing operations, each including the common processing operation and one corresponding individual processing operation, upon the input packet to generate the first output packets to the first egress ports, respectively.

12. The packet processing method of claim 11, wherein the first information is a port bit map (PBM).

13. The packet processing method of claim 11, wherein the second information records each packet processing command of the common processing operation.

14. The packet processing method of claim 11, wherein the second information records a command bucket pointer which points to a command bucket, and the command bucket stores each packet processing command of the common processing operation.

15. The packet processing method of claim 11, wherein the third information records an index value of an entry in a multicast table; the entry is associated with a plurality of multicast lists corresponding to the first egress ports, respectively; each of the multicast lists records a command chain node (CCN) pointer; and the CCN pointer points to a CCN having at least one command bucket pointer each pointing to a command bucket corresponding to an individual processing operation involved in generating an output packet.

16. The packet processing method of claim 15, wherein a command bucket pointed to by one of the at least one command bucket of the CCN includes a next command bucket pointer which points to a next command bucket.

17. The packet processing method of claim 15, wherein at least one of the multicast lists further includes a next multicast list pointer which points to a next multicast list; and the next multicast list records a CCN pointer which points to a CCN having at least one command bucket pointer each pointing to a command bucket corresponding to another individual processing operation involved in generating another output packet.

18. The packet processing method of claim 15, wherein the CCN further has a next CCN pointer which points to a next CCN, and the next CCN has at least one command bucket pointer each pointing to a command bucket corresponding to the individual processing operation involved in generating the output packet.

19. The packet processing method of claim 11, wherein the third information records at least one command chain node (CCN) pointer, and the CCN pointer points to a CCN having at least one command bucket pointer each pointing to a command bucket corresponding to an individual processing operation involved in generating an output packet.

20. The packet processing method of claim 11, further comprising:
generating a plurality of second output packets by processing the input packet according to the packet processing list, wherein the step of generating the second output packets comprises:
reading fourth information indicative of a plurality of second egress ports from an egress port field of a second session of the packet processing list;
reading fifth information only indicative of another common processing operation from a common processing field of the second session of the packet processing list;
reading sixth information indicative of a plurality of individual processing operations respectively involved in generating the second output packets from an individual processing field of the second session of the packet processing list; and
performing a plurality of second packet processing operations, each including the common processing operation, the another common processing operation and one corresponding individual processing operation, upon the input packet to generate the second output packets to the second egress ports, respectively.

21. A packet processing apparatus, comprising:
a forwarding decision making circuit, configured to generate a forwarding decision for an input packet; and
a packet processing list constructing circuit, configured to receive the forwarding decision and create a packet processing list of the input packet according to the forwarding decision;
wherein when the forwarding decision indicates that the input packet is required to undergo a plurality of first packet processing operations, each including a common processing operation and an individual processing operation, to generate a plurality of first output packets forwarded via a plurality of first egress ports, respectively, the packet processing list constructing circuit records first information indicative of the first egress ports in an egress port field of a first session of the packet processing list, records second information indicative of the common processing operation shared by all of the first packet processing operations in a common processing field of the first session of the packet processing list, and records third information indicative of individual processing operations of the first packet processing operations in an individual processing field of the first session of the packet processing list.

22. A packet processing apparatus, comprising:
a packet processing list constructing circuit, configured to create a packet processing list for an input packet; and
a packet processing circuit, configured to receive the input packet and the packet processing list, and generate a plurality of first output packets by processing the input packet according to the packet processing list;
wherein the packet processing circuit reads first information indicative of a plurality of first egress ports from an egress port field of a first session of the packet processing list, reads second information indicative of a common processing operation from a common processing field of the first session of the packet processing list, reads third information indicative of a plurality of individual processing operations respectively involved in generating the first output packets from an individual processing field of the first session of the packet processing list, and performs a plurality of first packet processing operations, each including the common processing operation and one corresponding individual processing operation, upon the input packet to generate the first output packets to the first egress ports, respectively.
